(19) United States
(12) Patent Application Publication
(10) Pub. No.: US 2011/0113383 A1
(43) Pub. Date: May 12, 2011

(54) Apparatus and Methods of Computer-Simulated Three-Dimensional Interactive Environments

(76) Inventors: Denis Dyack, St. Catharines (CA); James O'Reilly, Fonthill (CA); Henry C. Sterchi, Redmond, WA (US); Rich Barnes, St. Catharines (CA)

(21) Appl. No.: 13/003,987

(22) PCT Filed: Jul. 14, 2008
(86) PCT No.: PCT/US08/69907

§ 371 Date: Jan. 13, 2011

(51) Int. Cl. G06F 3/048; G06T 15/00

(52) U.S. Cl. 715/850; 345/419

(57) ABSTRACT

Computer-simulated three-dimensional environments include automatable and/or constrainable camera control, for video gameplay, real estate and/or landscape demonstrations, or any other digitizable environment. In gameplay applications, the system can be customizably programmed to automatically adapt to the environment based on the player's location within the virtual environment, information about what the programmer believes is relevant (or wants to make relevant) in the scene being displayed, and other factors. Certain embodiments of the inventive apparatus and methods generally automatically incorporate and honor the “rules of cinematography,” but also preferably include other “action video game” principles that can override or trump those rules.

### FIELD OF THE INVENTION

The present invention relates generally to computer-simulated three-dimensional environments, such as can be generated and displayed interactively on computer monitors or similar displays. More specifically, the invention relates to systems having automatable and/or constrainable camera control within an interactive computerized/digitized environment. Among other applications, the invention is useful for video gameplay, real estate and/or landscape demonstrations, or any other digitizable environment. As a new gameplay feature for video games (such as third person games and the like), the camera system invention can be customizably programmed to automatically adapt to the gameplay environment based on the player's location within the virtual environment, information about what the programmer believes is relevant (or wants to make relevant) in the scene being displayed, and other factors. Among other things, the invention can enhance such gameplay by allowing the user to focus on playing the game, rather than having to also worry about the complexity of controlling the camera and the corresponding view being displayed to the user.

Certain embodiments of the inventive apparatus and methods generally automatically incorporate and honor the “rules of cinematography,” but also preferably include other “action video game” principles that can override or trump those rules. For example, in certain embodiments of the technology within an action video game, programmers will not want to take liberties that are taken when the rules of cinematography are used in movies (such as removing certain objects from a camera shot or automatically adjusting the position of one of the people within the camera shot). If applied to certain high/fast action video games, those “movie” liberties (dictated by strict adherence to the “rules of cinematography”) would disrupt the gameplayer's immersion into the virtual world, rather than more closely mimicking actual physical realities.

### BACKGROUND OF THE INVENTION

As with most or all computer technologies, the use and complexity of graphical, digital “environments”, and the ability to allow users to interact within those simulated environments, have evolved significantly over the years. Applications of such technologies and systems are quite varied (including, by way of example and not by way of limitation, 3D CAD programs, architectural modeling software to provide virtual tours of actual or virtual homes or landscapes, and others). Among other things, this evolution has included the ability to create and “travel” through much more complicated and much more realistic virtual worlds, at much faster “speeds” than were achievable even a few years ago.

Among the many examples of those technologies are computer video games. Early two-dimensional games such as Pong required only basic input from a user/player, such as moving to the right or the left on the screen. As part of this evolution, other controls were added (such as guns or other weapons, thrusters or other ways to move things on the screen across both of the two dimensions of the video display, etc.).

These games further evolved to include three-dimensional (3D) experiences. Such video game methodology typically includes using a “camera”, or a displayed point of view in the digital three-dimensional world of the game. This displayed point of view or camera typically is controlled by the user, to select and manipulate the view displayed on the video monitor or other display during gameplay.

Three-dimensional games typically are either played in the first person or third person. In a first person game, the camera takes the position of the “eyes” of the player. In a third person game, the camera displays both the player's character and the surrounding environment, and the user (the human being playing the game) views the action on the screen from the perspective of a “third person”, rather than viewing it directly through the eyes of one of the characters in the game.

In third person video games, the camera system apparatus and methods conventionally have used either (a) fixed camera positions that change as the player moves from one scene or location to another within the digital environment, or (b) a user-controlled camera which is positioned slightly above and behind the player. Between those two, the latter approach typically can provide a more dynamic and engaging user experience (such as by simulating the need for, and/or the effect of the player to turn his head to the right or left or to look up or down, or otherwise feel more immersed within the digital environment). However, that latter approach typically requires that the player has to not only move his character throughout the digital environment (and shoot weapons or take other actions such as jumping, swinging his arms or kicking his legs, etc.), but also manipulate controls to adjust the camera position or viewpoint, via an additional controller or input mechanism.

In many such video games, the player typically is in control of the gameplay, to at least some degree. As part of that control, the player's control of the camera typically not only affects the aesthetics of the game experience, but also can be a means by which the player interacts in the virtual world. Because the main focus of the player typically is achieving various game objectives (i.e. navigating around objects, attacking enemies, jumping from platform to platform) in order to advance and/or score well within the game, some game designs have tended to emphasize the most functional view of the gameplay action, with little regard to the aesthetics.

Although computer memory, graphics capabilities, processing speed, and other “limits” on video experiences also continue to evolve, at any given point in time (and on any given hardware/software system) there are in fact some limits as to what can be programmed into a digital environment experience such as a video game. These limits can sometimes require a balancing of competing factors, so as not to overtax the hardware/software in a way that completely locks up the display/program or makes it so “slow” or “laggy” that the user's experience is negatively affected. In video games, such factors can include speed and/or complexity of the action within the environment and/or by the game character (i.e., the ability to do more complicated moves, etc.), as well as the “cinematography” of the user's experience (i.e., to provide a high degree of visual “immersion” of the user into the game experience, such as by affording the user “control” of the camera). With the evolution of narratives (or “story lines”) in video games, for example, cinematography has become even more important in video games as a means to convey story and emotion. To improve the visual fidelity of video games, camera systems are being developed for those games that can provide increased cinematic capabilities (that can make the graphical experience more like a movie). However, the speed and/or complexity of the player's action (or other virtual things with which the player interacts in the environment) can push or reach the aforementioned limits on hardware/software/etc., and therefore can require that camera shots become more conservative, again preferring function over form (for example, fewer close-ups, less richness of detail in the player's surroundings, etc.).

As a consequence of dealing with the aforementioned “limits”, prior art video games (or similar digitized, interactive virtual or simulated experiences) tend to one of two types: (a) those that mostly focus on cinematography but often suffer with “lesser” gameplay, and (b) those games that mostly focus on gameplay but often suffer with “lesser” cinematography.

Other factors impact the approach to programming such virtual environments and experiences. For example, human users have some limit on their abilities to “multi-task”, and those limits vary across the human population to which the video game or other virtual program may be directed. In 3D video experiences, for example, if a player has to devote too much attention and effort to “controlling” the camera, it can detract from or otherwise negatively impact their ability to focus on the actual “gameplay” (fighting the bad guys, avoiding various perils in the game, etc.).

U.S. Pat. No. 6,040,841 to Cohen et al. illustrates one alternative approach to camera control within a three-dimensional virtual environment. According to its Abstract, the '841 patent teaches to “automatically apply[ ] rules of cinematography typically used for motion pictures. The cinematographic rules are codified as a hierarchical finite state machine, which is executed in real-time by a computer in response to input stimulation from a user or other source. The finite state machine controls camera placements automatically for a virtual environment. The finite state machine also exerts subtle influences on the positions and actions of virtual actors, in the same way that a director might stage real actors to compose a better shot . . . .” Although this approach provides some benefits of achieving “cinematographic effects”, it is directed to graphically simulating “communication” or talking between virtual actors in the virtual environment. As such, it may have some efficacy in applications such as chat rooms or the like (in which the focus is not “fast action”, for example, but merely having conversations between virtual actors), but as mentioned above it has several shortcomings that make it less than optimum for simulated gameplay in an action video game or other such applications.

For example, the '841 patent teaches using a finite state machine to control the camera (“in this certain circumstance, here's how the camera should behave.”). In other words, the camera is limited to one of the states that has been set up or pre-programmed. Using a virtual chat room as an example, a user instructs his or her avatar (virtual actor) to go over and have a virtual conversation with another avatar. This is relatively easy to do in a chat room or party room program or application, where you simply have four or five people walking around. It is not easy to do in video games, especially in fast/high action, highly-detailed video games.

As another example of shortcomings of the '841 patent, it teaches to “move” or sometimes even take out (erase from the camera view) one or more of the other avatars (the ones not involved in the user's chat session), if that other avatar is in the way of framing the camera view in an optimal way according to the “rules of cinematography.” Although a video game could use such an approach, it would be at the cost of causing a disruption in the user's “immersion” into the virtual world.

Thus, the '841 patent appears to describe a discrete state of avatar action, and is “action driven”—that is, the user determines which of several discrete states the camera will be in by selecting from a given menu of avatar actions. The camera stays in its given state until the player executes another action. For example, if the user selects the action “A talks to B”, the '841 patent camera stays in that specific state until the user gives another action command (such as “I walk away”). Within that given single relatively static state, the '841 patent system says. “I need to frame ‘A’ talking, almost to the exclusion of everything else.” For example, as noted above, if things/avatars are not immediately involved in the action that the user has selected, the '841 patent system teaches to even remove things from the scene, if that helps frame the camera view in an optimal way according to the “rules of cinematography.”

### SUMMARY OF THE INVENTION

For the purpose of summarizing the invention, certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages that may be taught or suggested herein.

The interactive, cinematic camera system of the invention can help balance some of the various design considerations and limitations discussed above, to provide an improved user experience in 3D virtual environments such as video games. The invention can help maintain a dynamic, artistic, and contextually relevant composition while remaining conducive to gameplay or other interaction with the digital environment. In a preferred embodiment, the camera system is adaptive to the player, while maintaining a vision established by the cinematographer and/or game designer.

Another description of the balance that can be improved via the invention: if the cinematography becomes too pre-scripted, the player/user does not feel in control; if the camera instead is too passive, the experience can become dull for the player, and/or can cease to be as “cinematic” as it might otherwise be. As described herein, the present invention provides an improved balance of those considerations, which is particularly useful in certain applications such as action video games.

In certain embodiments, the present invention provides a new camera system which is capable of automatically adapting in desirable ways to the gameplay/digitized environment. Preferably, this automatic adjustment can occur at all, or substantially all, times during the user's/player's experience, and thereby can avoid or reduce the cinematic or other limitations or distractions of prior art systems (such as ones requiring user control of the camera or having fixed camera positions).

In certain embodiments, the present invention provides an “intelligent” or algorithm-driven camera system for third person games, using the player's own gameplay movements and actions as input to determine and frame the camera view or scene, without any need for separate user input regarding the “camera” (e.g., without the player having to independently operate the camera). The algorithm(s) involved can take into account a wide variety of factors, including certain cinematographic or other “rules” that can be created and/or selected by a programmer, by the user (such as providing the opportunity for various styles, etc.), or otherwise. Among other things, such an algorithmic approach to camera control can take into account and analyze relevant information in the scene, and then automatically direct/move the camera view experienced by the user according to the rules within the algorithm(s) or similar programming structure. Examples of such “scene information” include the position of the player-controlled main character, the position of other characters in the scene, environmental features, various special effects, and the occurrence of special events during gameplay.

In certain embodiments, the camera system is at least “semi-autonomous”, so that certain input from the user can be weighted by the algorithm(s) so as to give the user the sensation of “taking control” of the camera (albeit preferably in a limited fashion and/or for a limited time, because reverting “all” camera control back to the player would reduce or eliminate the desirable “automation” of the camera control that can be achieved with the invention). As also described herein, by heavily weighting (valuing) the player's avatar as a point of interest (POI) within the virtual world, a programmer/designer can increase the probability that the avatar will be in the view that is selected and displayed to the player. This can be very useful in many applications of the invention, such as the action video game systems used within certain examples described herein.

The “programmability” of the camera control can be varied, and can combine multiple concepts that a game designer may deem desirable. Examples include obstruction-correcting cameras that adapt according to the nature of the environment in order to allow for the best shot possible. The system also can include emotionally aware and expressive cameras that react according to the emotions of the character, and the mood of the scene. For example, if a character's emotional involvement is low, the camera shots can be programmed to be long (such as using a wide field of view and being relatively further from the subject); if his emotional involvement is neutral, the camera shots will be medium size/speed; and if the character has high or subjective emotional involvement, the camera shots will be low angle and medium shots. By way of further examples, the system of the invention can include dialogue-driven cameras that understand the rules of cinematography in a dialogue setting (e.g. complimentary angles, 180 degree rule, subjective vs. objective, etc.), for screen situations in which multiple characters talk to each other or are otherwise “together”. Preferably, however, the present invention uses an approach such as a “state stack” or “modifier stack,” so that “rules” (such as the rules of cinematography) do not have such “absolute” control over camera view framing and behavior.

The present invention also allows programmers and designers to “tag” and/or apply a “weight” or value to a virtually unlimited set of “points of interest (POIs)”, and make those POIs available for possible interaction with the user's avatar or other purposes. In certain embodiments, it can provide a substantially dynamic virtual interaction, such as by reevaluating the camera shot on a virtually constant basis.

These and other objects, advantages, and embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a block diagram or flowchart illustrating certain aspects of an embodiment of the invention, entitled “Camera Position/Movement Logic”;

FIG. 2 is a block diagram or flowchart illustrating certain aspects of an embodiment of the invention, entitled “3-Point Iterative Algorithm”;

FIG. 3 is a block diagram or flowchart illustrating certain aspects of an embodiment of the invention, entitled “Choosing a New Camera”;

FIG. 4 is a block diagram or flowchart illustrating certain aspects of an embodiment of the invention, entitled “Scoring a Camera”;

FIG. 5 is a block diagram or flowchart illustrating certain aspects of an embodiment of the invention, entitled “Finding Best Point of View (POV)”; and

FIGS. 6A, 6B, and 6C are different perspectives of an illustrative embodiment of the invention, illustrating a user's avatar 10, other POIs (12, 14, 16, and 18), and a plurality of cameras (22, 24, 26, 28, 30, and 32). FIG. 6A is a perspective view taken from nearly straight overhead; FIG. 6B is an elevation perspective view taken along line 6B-6B of FIG. 6A; and FIG. 6C is similar to FIG. 6B but taken from a slightly higher position and angled downwardly.

### DETAILED DESCRIPTION

Embodiments of the present invention will now be described with references to the accompanying Figures, wherein like reference numerals refer to like elements throughout. The terminology used in the description presented herein is not intended to be interpreted in any limited or restrictive manner, simply because it is being utilized in conjunction with a detailed description of certain embodiments of the invention. Furthermore, various embodiments of the invention (whether or not specifically described herein) may include novel features, no single one of which is solely responsible for its desirable attributes or which is essential to practicing the invention herein described.

Although the methods of the invention are described herein with steps occurring in a certain order, the specific order of the steps, or any continuation or interruption between steps, is not necessarily intended to be required for any given method of practicing the invention.

As indicated above, although much of the description herein focuses on applications such as action video games, persons of ordinary skill in the art will understand that the invention has utility in a broad range of applications other than games. Three-dimensional architectural renderings, virtual tours of art galleries and/or other institutions, real estate websites or similar displays, and other interactive virtual environments are just some of the many examples of such applications. Thus, persons of ordinary skill in the art will understand that various terms used herein may have similar or identical concepts in industries and applications other than video games.

Likewise, persons of ordinary skill in the art will understand the basic concepts of constructing virtual 3D environments and avatars, having those avatars interact with those environments, and using cameras within that environment to provide the human player(s) an interface into those virtual worlds. They also will understand that, although much of the description herein refers to avatars, certain applications may not use “avatars” (or at least not ones that are visible). For example, they may attempt to give the user the illusion of “first person” traveling through the virtual world. In these cases, the system preferably will frame the shot based on the “non-avatar” POIs that are in the relevant scene or area of the virtual environment.

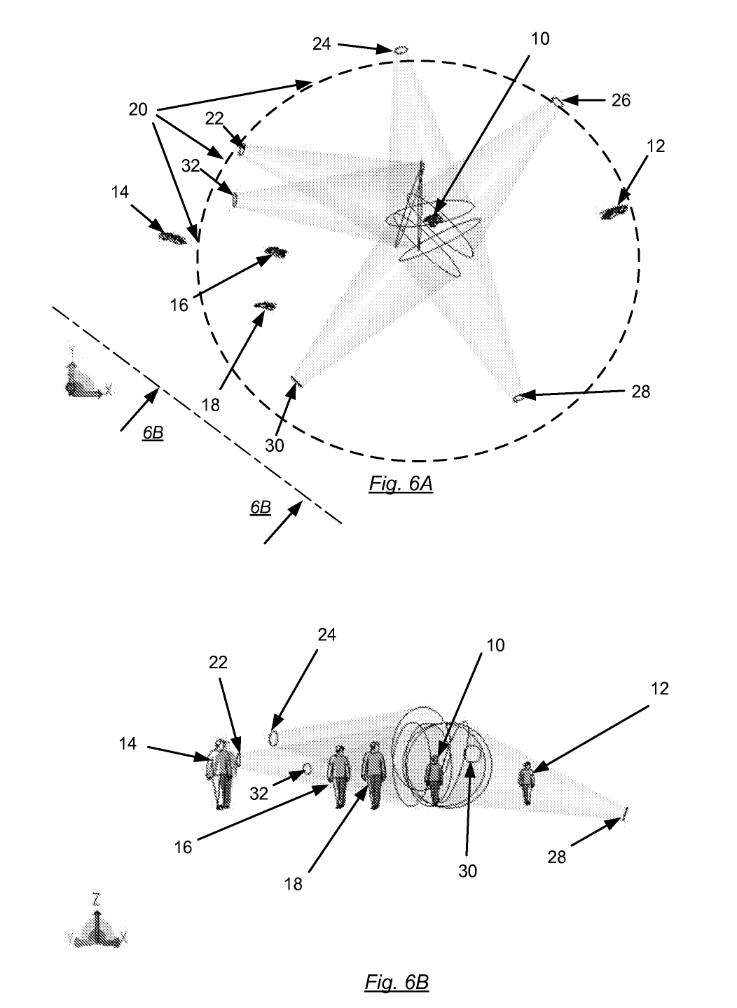

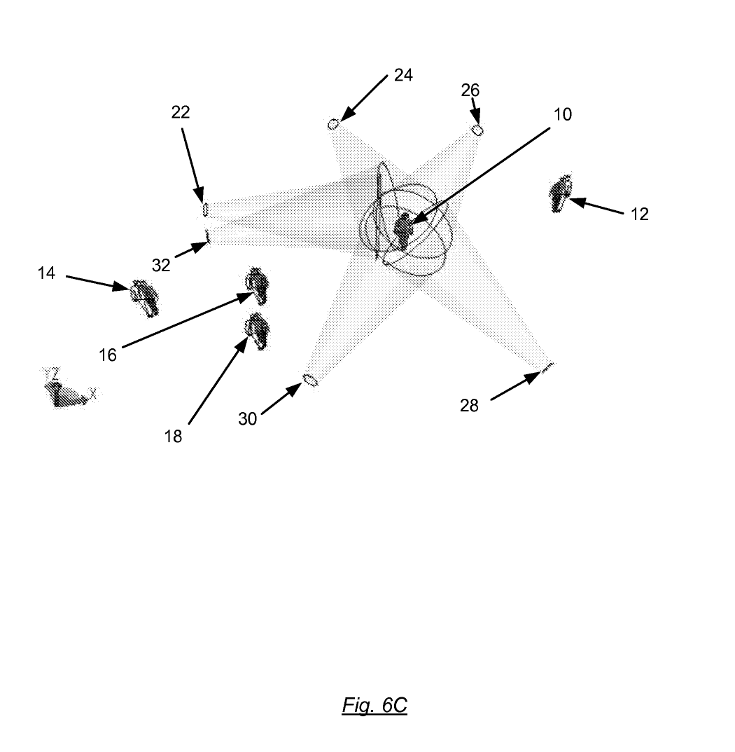

Some of the basic logic and concepts involved in the methods and apparatus of the present invention can be appreciated by reference to the attached drawings. As shown in FIGS. 6A, 6B, and 6C, an avatar 10 is typically designated as one of several points of interest (POIs) within the virtual environment. As further explained below, by “weighting” the avatar sufficiently (i.e., making the avatar of sufficient “importance”), the programmer or designer can make it more likely (or possibly even “certain”) that the camera that is selected (to be displayed to the human user) will be one that includes a view of the avatar. Other POIs are shown generically at locations 12, 14, 16, and 18. Although these are illustrated as other “person” avatars, as indicated elsewhere these POIs can be any desired “thing” in the virtual environment, including fixed or movable elements of scenery, pathways, enemy weapons or avatars, etc. Each of these elements preferably can be created and assigned a “weight” by the programmer or designer, to provide the desired gameplay or other interaction for the human user.

A ring of cameras 20 is also illustrated in FIGS. 6A, 6B, and 6C, as including cameras 22, 24, 26, 28, 30, and 32. Persons of ordinary skill in the art will understand that any suitable number and arrangement of cameras can be used within the invention depending on the specific application, and that the cameras can be (among other things) programmed so that they “travel” with the player's avatar as it moves through the virtual world. Among other things, cameras might not completely surround the avatar, might not be coplanar with each other, may be distributed around the avatar at equal intervals/angles from each other, etc. By way of example of non-coplanarity, camera 28 is positioned at about the “floor” of the environment, so that it generates an upwardly angled shot. In contrast, camera 22 is positioned to shoot from about “chest height” of the avatar. As discussed elsewhere, in many applications “above and from behind the avatar” will be a preferred/useful camera position.

Persons of ordinary skill in the art also will understand that, in many video games and other applications, the user's avatar “moves” through the virtual world, either at the user's direction or otherwise. Accordingly, the positional relationship of the various elements illustrated in FIGS. 6A, 6B, and 6C can be very dynamic, if (for example) a player's avatar is running, jumping, spinning, or otherwise engaged in various “movement” activities within the virtual world.

During the interaction of the player/avatar within the virtual world, the view displayed to the human user can be from any of the cameras illustrated in FIGS. 6A, 6B, and 6C. Various embodiments of the invention include methods and apparatus for providing a dynamic and automated selection from among those cameras, to provide to the user a desired visual experience to enhance the user's interaction with the virtual world. Depending on the particular application, that experience can be customized across a wide range of balancing of functionality and aesthetic experience for the user.

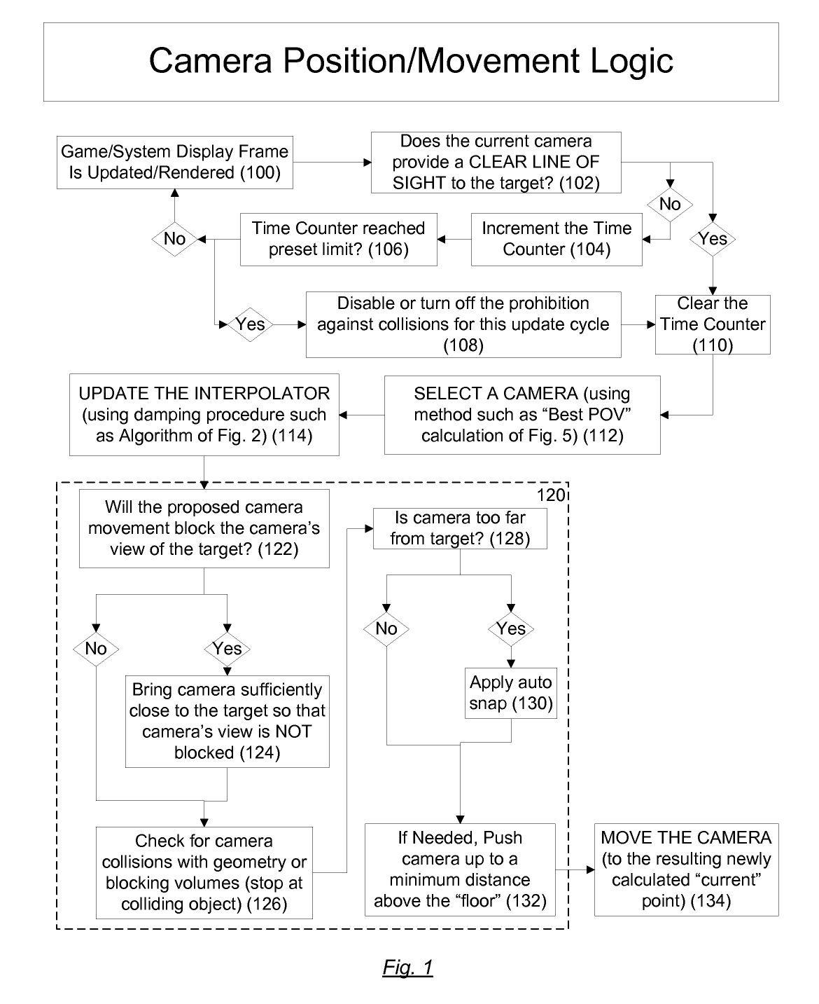

In certain embodiments of the invention, the overall logic of the camera selection, position, and movement can be illustrated as shown in FIG. 1. This method preferably includes one or more of the steps, methods, and/or apparatus illustrated in that Figure.

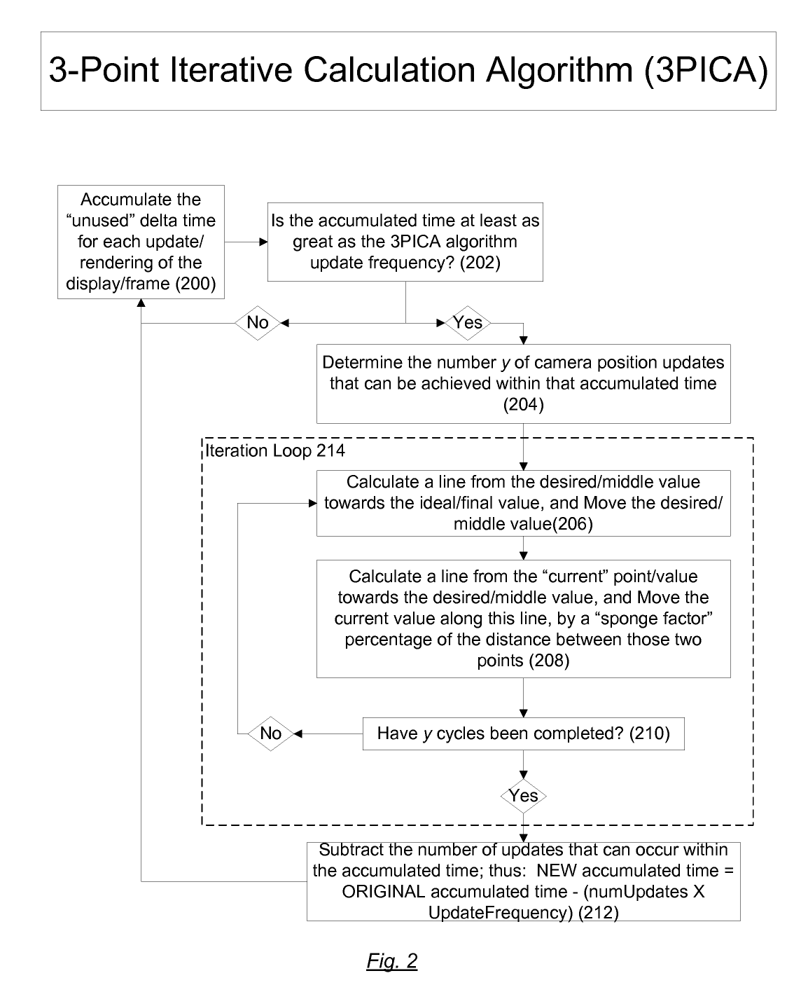

As indicated in block 100, the game/system display frame is updated/rendered on a periodic basis (typically many times/second). Those rapid updates/renderings can each be slightly different from each other, resulting in the illusion (to the human eye) of movement. Preferably, this game display refresh rate can occur at a different and/or varying time interval from the frequency of the update calculations of the movement damping procedure (such as executing the Algorithm of FIG. 2). Also preferably, the movement damping procedure/calculation (see FIG. 2) occurs on a fixed/constant time interval, to permit desirable control of the speed and/or acceleration of the camera as it moves through the virtual environment, so as to avoid “jarring” the human user. Such “jarring” or other negative experiences can occur if a human user is confronted with displays of jerky or “too-rapid” camera movements.

Persons of ordinary skill in the art will understand that, although the example described in reference to FIG. 1 is “initiated” by each display frame update, other embodiments can be triggered by other events. Preferably, the process is triggered as often as is required to maintain visual quality within the simulation, as perceived by the human users of the system. Examples include, without limitation, initiating the various processes of the invention based on a fixed timer/interval, a random time generator interval (perhaps constrained within certain time limits), etc.

As indicated in block 102, each time the system frame renders/updates, check: does the current camera provide a clear line of sight to the target? If it does, the Time Counter is cleared (set to zero) as at block 110. If not, increment the Time Counter (accrue the time/game update frames that the camera has been at the current location/point) (see block 104), and then determine whether the Time Counter has reached its preset limit (block 106). If it has not, the logic returns or loops back to await the next display frame update (block 100) which kicks off the cycle again.

If instead the Time Counter has reached its preset limit, this typically indicates that the camera has not moved for a number of frames. Although such a failure to move can result from a player simply sitting idly (rather than moving his avatar), it also can result from other causes that could “lock” the system logic. Using the video game example, if a camera is trailing behind an avatar and the avatar goes through a doorway, if the door shuts before the camera makes it through that doorway, certain “reality rules” might stop the camera from being able to follow the avatar through that door (e.g., cameras normally can't travel through solid objects such as doors). To handle such situations, once the Time Counter limit has been reached (with no camera movement), the system logic preferably disables or turns off the relevant rules (such as the aforementioned prohibition against collisions or moving through solid objects). This is illustrated in block 108 of FIG. 1. Preferably, this disabling is only for the current update cycle, and the rule is “reactivated” for the next frame display update cycle. In other words, in such embodiments and in such situations, the camera is permitted to “break” certain “rules” and move in ways that normally would not be permitted by the system.

As indicated in block 112 of FIG. 1, the logic preferably next selects a camera. This can be done with any suitable method, including the exemplary method illustrated in the “Finding the Best Point of View (POV)” calculation process illustrated in FIG. 5.

In order to avoid “jarring movement” of the camera (which could disorient or, in the extreme, even nauseate the user), the system preferably includes one or more means for “dampening” the movement that might otherwise occur. In the embodiment illustrated in FIG. 1, an interpolating damping procedure is used (such as the one illustrated in the Algorithm of FIG. 2). This interpolator preferably uses a “3-point” iterative algorithm, using the following three points for each iteration: (1) the “current point/location” at which the camera is located at the time of the calculation; (2) an “ideal point/location” which is the point selected as the “Best POV” (calculated in block 112); and (3) a “desired point/location” which is a point between the “current” and the “ideal” points, and which is used as a dampening link between the two. For certain situations (such as when the player's avatar is still and there are no “targets” around or enemies approaching within the virtual world), the three points can be at the same location. Once something forces the ideal point to move away from the current point, however, the algorithm can be used to help calculate the camera's position and movement, for an improved player experience.

In order to generate a more “normal” sensation of movement for the user, the camera preferably does not immediately track or move to the “ideal point”. Instead, the 3-point iteration allows the “current” point of the camera (the one being viewed by the user) to gradually accelerate toward the ideal point, and gradually slow down and stop at the ideal point (if the user/avatar ever catches up with the “ideal point”). Preferably, the interpolator calculates a proposed (1) movement of the “desired point” of the camera toward the “ideal point” by a distance determined by a preset “desiredSpeed” variable; and (2) movement of the “current point” of the camera toward the “desired point” by (a) the distance between the current and desired points multiplied by (b) a preset “sponge factor,” which is another variable that can be set by the programmer or designer (see block 114).

In addition, a number of “movement modifiers” can be programmed into a “modifier stack” of factors that the logic considers during each cycle of FIG. 1. Examples of “post interpolation” modifiers are shown as various blocks within area 120. As shown in block 122, one such modifier can focus on whether the proposed camera movement (calculated by the interpolator in block 114) will block the camera's view of the target. If it will, that or another modifier can move the proposed camera position sufficiently close to the target so that camera's view is NOT blocked (see block 124). If the view is not blocked, the system can proceed to another modifier such as block 126, which can check for camera collisions with geometry or blocking volumes (stop at colliding object).

Other examples of modifiers are shown in blocks 128, 130, and 132. In block 128, a modifier logic monitors whether the proposed movement of the camera will place it too far from the target. If yes, an “auto snap” or similar logic can be used (see block 130) to force the camera to “snap” to a sufficiently close distance to meet whatever parameters have been programmed in that regard. In block 132, a modifier can determine whether to push the camera up to a minimum distance above the “floor” or other surface of the virtual environment.

Persons of ordinary skill in the art will understand that the “modifier stack” concept of the invention can include modifiers that are applied after the interpolator calculation, before that calculation, or both. If after (or “post”) modifying the calculated position, certain applications of the process can be described as “massaging” the calculated camera position.

Finally, after selection of the camera, interpolation calculations, and application of any modifiers, the “new” position of the camera is determined (see block 134), and the program preferably moves the camera to that position. Depending on the application and the circumstances, the “move” actuated in block 134 could be a move of zero distance.

Persons of ordinary skill in the art will understand that the foregoing modifiers are merely examples, and that virtually any desired factor can be incorporated into the “modifier stack” to affect the camera movement. As previously mentioned, these modifiers can even include some degree of “camera control” by the user (although preferably the user is never given complete camera control, as that would remove many of the benefits that can be provided by the invention). Moreover, the order of application of the modifier calculations can be varied to suit the particular application for which the invention is being used, and there may not be any modifiers at all in certain applications.

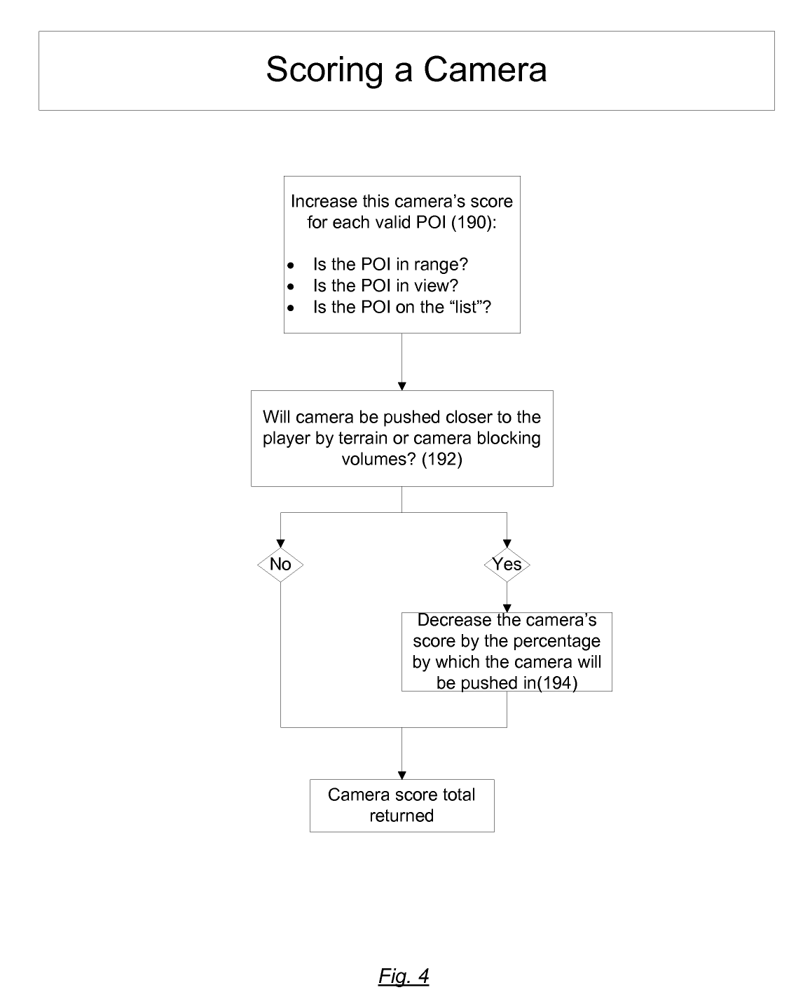

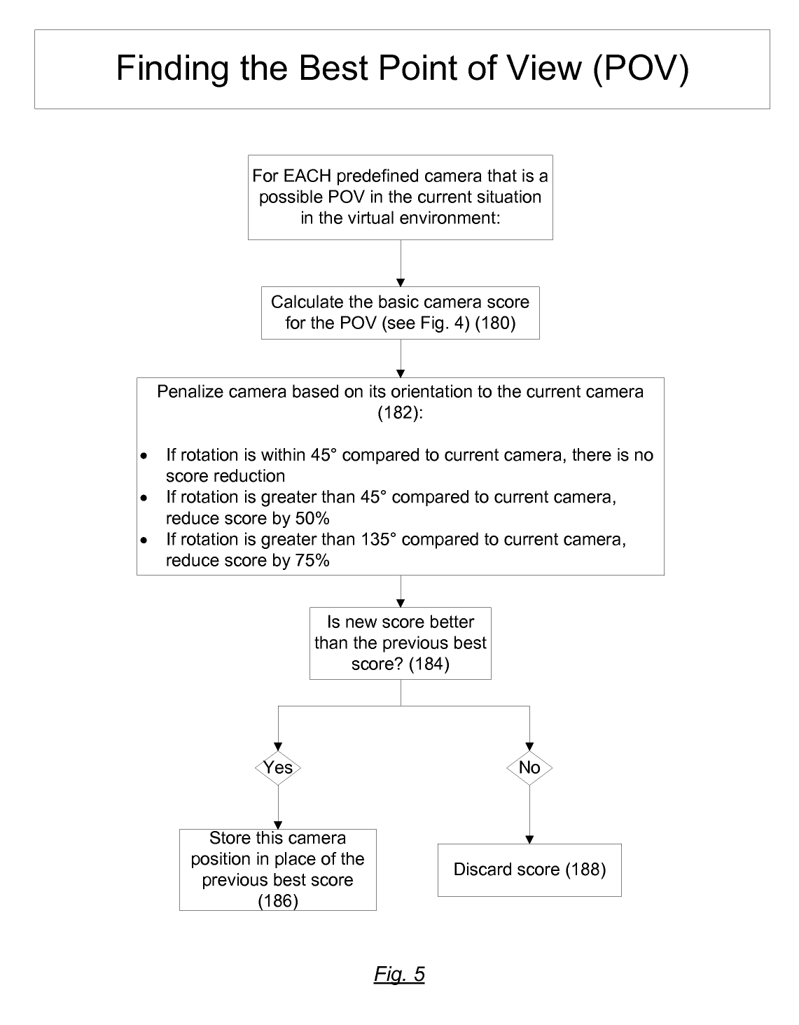

As shown in block 112 of FIG. 1, the system preferably “automatically” selects a camera from among various potential cameras. An example of such a selection process is illustrated in FIG. 5, entitled “Finding the Best Point of View (POV).” For each predefined camera that is a possible POV in the current situation in the virtual environment, the system preferably calculates a basic camera score for the POV (see block 180). That calculation can be accomplished in any suitable manner, including by way of example via the process illustrated in FIG. 4.

Once that basic score has been calculated, the score can be further “adjusted” for other factors. In block 182, for example, the score of a POV can be “penalized” or discounted based on the amount of rotation that would be required relative to the current camera. Because large swings in camera orientation can be disorienting to a user, typically the programmer will discount the score further as the necessary “orientation swing” increases (although the example of FIG. 5 illustrates only a three-tiered discounting scheme, persons of ordinary skill in the art will understand that any number of stepped discounts or other approaches could be used within this step of the process). Once any such “discounting” (or alternatively, “enhancement”, if a programmer uses some factor(s) that he/she deems make the camera more desirable) has been applied to the camera score, that score is compared to the previous “best” score (of those calculated during this cycle of “finding the best POV”) (see block 184), and if better than that score, its associated camera position is saved/stored (see block 186). If the score is not better than that previous score, the score and its associated camera position are discarded (again, for purposes of this specific cycle of “finding the best POV”; see block 188).

One of the many approaches to the camera scoring discussed above is illustrated in FIG. 4. For example, for applications such as video games (or other “target-rich” applications), a camera's score can be increased for each valid target that would be displayed if that camera were to be selected (see block 190). Other “modifiers” can be programmed in the scoring, such as the one illustrated in block 192 (will the camera be pushed closer to the player by terrain or by camera blocking volumes within the virtual environment?). If yes, the camera's score can be decreased, such as indicated in block 194 (by the percentage by which the camera will be pushed in).

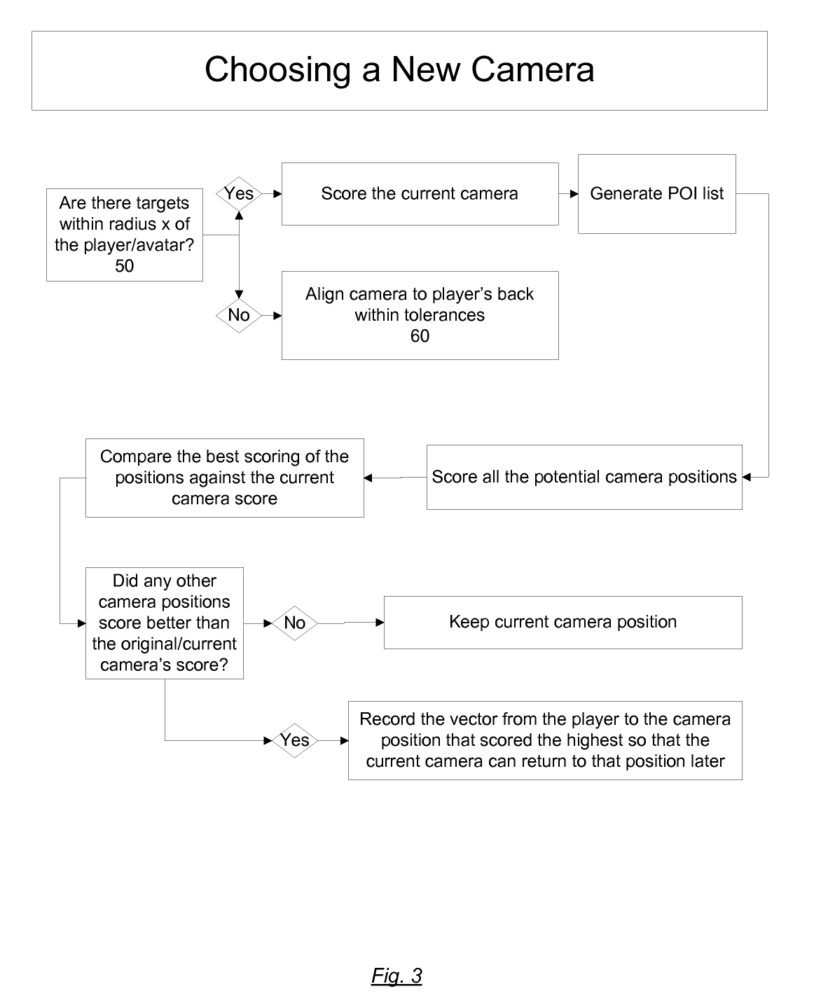

Instead of a finite state machine approach such as taught in the aforementioned '841 patent, the present invention preferably uses an approach such as a “state stack” or “modifier stack.” Although the camera has a “base” behavior that is determined by the state, that state is determined only in a very simple manner. For example, the camera can be constrained to be a chase camera or a rail camera (FIG. 3 and FIG. 5 illustrate examples of such base behaviours). Beyond that simple base state or base behavior, the present invention can use a modifier stack so that, for example, any action that a user imparts to his avatar causes the program to move through a series of modifiers that travel with the camera. This provides a much more dynamic feel for the resulting video display seen by the user.

Preferably, the present invention also allows a programmer or designer to tag points of interest (POIs) within the virtual world, and uses those POIs dynamically to calculate and select a camera for display to the user, the position of the camera, and other things. The present invention also preferably reevaluates the camera shot on a virtually constant basis—such as every 1/30 of a second. This gives the user the impression that the shot is constantly moving as the user moves through the virtual world. In effect, this system virtually constantly evaluates the camera position, the player position, and the positions of the POIs, all relative to each other on a per frame basis (approximately 30 Hz).

For many applications of the present invention, programmers and designers will constrain the camera apparatus and methods so that it cannot “remove” anything from the virtual scene (just as things do not spontaneously move or disappear in the real world). Among other things, such changes would or could disrupt the user's sense of continuity and immersion into the virtual world (for example, if the camera were to suddenly cut from one location to another without any action on the user's part).

In contrast to the “cinematographic events” taught in the aforementioned '841 patent, preferred embodiments of the present invention do not have a module that (a) determines what kind of an “event” is occurring, and then (b) passes that information to another module. Instead, the present invention preferably depends on the mode picked by the game designer. The designer can establish a number of POIs (e.g., things about which the game designer has determined that the game should know). Typically, these POIs can be things of relevance to the eventual player of the game. In addition to “mobile” items such as avatars that can move through the virtual world, these POIs can include other mobile items (such as enemy targets) as well as items that have relatively “fixed” positions within the virtual world.

As a player navigates through the virtual world, the camera preferably takes into account points of interest, and attempts to frame the camera shot appropriately based on the weight that the game designer has given to the various points of interest (POIs), using the programming logic of the modifier stack or similar tool.

As will be understood by persons of ordinary skill in the art, programmers and/or game designers can use any suitable hardware and/or software tools to practice the invention. These include not only personal computers and handheld or other gaming systems, but more broadly tools such as any suitable programming languages, platforms, coding programs, rendering engines, and many others. At the present time, examples of such tools and languages include C, C++, and Java, consoles from Nintendo, Sony, Microsoft, or others, PCs or Apple (or other computers can be used), etc. The specific algorithms, hardware, console, and other “forms” of the invention are virtually unlimited.

In other words, the rendering engine, platform/console, and language used to practice the invention are arguably immaterial. Instead, some of the main features of the invention that can be practiced in many different ways include having a three-dimensional rendering engine, points of interest (POIs) of what you want to display within the virtual environment, and a camera view into that virtual world. The logic, apparatus, and techniques of the invention can be adapted to any suitable programming language, platform, or other aspect of presenting and/or interacting with three-dimensional virtual environments.

In many applications and embodiments, the present invention can be implemented by the game designer or programmer selecting a single state (either programmatically, or through use of a game design tool) from one of a preferably small number of states, such as three states. Although certain embodiments of the invention could include a larger or even “large” number of states, a small number of states is easier to program and much more manageable than having to code many specific behaviours. Typically, the state chosen can provide a base behavior or motion for the camera. For example, in a wide open area of the virtual environment, a chase camera may be preferred, while in an enclosed space within the virtual environment, a camera that is constrained to a rail might be better suited (might be more likely to provide a desired gameplay experience for the user). Preferably, whichever of the states is selected, that state can handle and implement virtually any action by the user within the scene. The camera preferably also can take into account all of the relevant points of interest (POIs) as part of automatically determining the camera view, by using the modifier stack (the programming that “travels” with the camera) or similar technology.

Regarding the use of “cinematographic rules” or similar concepts (to achieve heightened cinematographic effects, for example), the present invention preferably includes some or all of those rules, but uses them only as guidelines. For example, for applications of the present invention involving an action video game, the invention preferably will not remove certain objects from the camera shot or automatically “move” or otherwise cause a discontinuity in the virtual world by adjusting the position of one of the people or objects within the camera shot. As another example, in many applications of the invention, the programmer/designer will attempt to avoid “cutting” any of the action within the virtual world. This is true even if such cutting would be more true to the cinematographic rules. Thus, the present invention sometimes overrides the cinematographic rules with certain other principles (such as the idea that you don't want to disorient a player by having certain objects suddenly disappear or be moved to a different position, without having had any relevant input from the user).

Thus, at least certain embodiments of the present invention can hold certain principles as being more important than the aforementioned “cinematographic rules.” These additional principles can include, by way of example and not by way of limitation, not disorienting the human player, not allowing things to be removed from the camera shot, making it a priority to keep the player's avatar on screen (in the selected camera shot), etc. In other words, the technology commonly used in movies (following the cinematographic rules) is different from the technology typically required in action video games (such as ones that can be created with the present invention). Said another way, action video games are a different medium than movies or the video technologies in which the '841 patent would be useful.

In certain embodiments, the present invention can use cutting or tweening to define motion from one camera position to another. Cuts provide an instantaneous transition from one view to another, but tend to disrupt gameplay. Tweening can be accomplished with, for example, a 3-point iterative calculation. In a preferred embodiments, the three points can be: the ideal position, desired position, and current position. In such embodiments, the ideal position as determined by the rest of the system can move to any location at any time. The desired position steps in a linear fashion in the direction of the ideal position, and the current position steps some fraction of the distance between it and the desired position. At rest (when the player/character is not moving within the virtual scene), all points are in the same location. During motion, however, the camera of the invention preferably automatically accelerates from rest, decelerates to rest, and smoothly deals with a dynamically changing target.

One embodiment of a preferred motion of the ideal position can be described using a number of tools. In certain embodiments of the invention, the various degrees of freedom of the camera motion can be independently constrained. In certain embodiments, the motion can be constrained to a point, spline, or plane, and the camera target (viewpoint) and actual camera can both move independently using the same algorithm. In some embodiments, functions describe the possible paths that can be taken from rotation around targets, to linked positions on geometric shapes where the camera position is derived from the position of the target.

In certain embodiments of the present invention, when the camera is unconstrained, it can use the aforementioned points of interest (POI) to determine the ideal location and rotation. Using a weighting schema (for example, a schema that takes into account attributes like the location on or off screen, angle off axis, unobstructed visibility, and/or other factors), both the current frame and a number of possible frames are evaluated and the highest score is determined to be the best position. Rulesets then determine the method of transitioning between the current and new best position, choosing a method of motion that does not break the rules of cinematography (cutting across the axis, tweening overhead, etc). The resultant camera motion of the invention provides a unique “cinema style” look and feel to an interactive experience such as an action videogame.

In accordance with an exemplary embodiment of the present invention, the present video game camera system apparatus automatically changes the apparent moving direction of the camera and/or modifies the apparent camera angle depending upon the controlled character's circumstance (e.g., he is inside a room, outside a room, on a ledge, behind a wall, running, jumping, swimming, scared, excited, isolated, anxious, surprised, etc.), the position of other characters in the scene, environmental features, various special effects, and the occurrence of special events during gameplay. If the camera system detects that, for example, a wall exists between, for example, the player controlled character and a camera point of view, a calculation is made as to the required camera movement to prevent the obstruction between the eye of the camera and the object. The camera is then automatically moved to a new position in accordance with the calculated moving angle. The camera perspective is automatically changed to select the best camera angle according to the character's circumstances so that the player can enjoy the visual effects being experienced in the three-dimensional world without having to control the camera him/herself.

In another exemplary embodiment of the invention, a video game system includes a control processor for playing a video game including a game character controlled by a player. A camera system apparatus communicates with a camera and determines the direction of movement of the camera and/or modifies the apparent camera angle depending on the player controlled character's circumstance. The position of the camera is modified during gameplay according to occurrences in the game, wherein a modifying amount is determined based on various factors, such as the character's circumstance, the position of other characters in the scene, environmental features, various special effects. As indicated above, the methods and apparatus of the invention are useful for a wide variety of three-dimensional virtual environments. Certain such video game environments can be described as having “targets” or points of interest (POIs) that the programmer/designer can “tag” or otherwise mark or use for possible interaction with the user's avatar or for other purposes.

For some “target rich” environments (such as shooting games, for example), the invention can be practiced by using a specialized weighting system to determine the ideal camera position. Under such an approach, and as illustrated in FIG. 3 (Choosing a New Camera), one “Post” Modifier within the “modifier stack” can check the area around the player's avatar (within the virtual world) for targets, and if any are found, can evaluate the best camera angle. This check or sweep is illustrated as logic/method steps and/or apparatus 50, and it can be configured or structured on any desired basis, including by way of examples, checking out into the virtual environment to a certain radius from the player/avatar, checking for certain types of targets, etc., or even combinations of such criteria.

If there are no targets within range (and/or that meet any other specified criteria), then the camera positioning system falls back upon the other PostMods in the programming stack (as illustrated by logic/apparatus 60). However, if the sweep or check locates one or more targets (or a predetermined minimum or maximum number of targets, for example), the PostMod can evaluate a number of possible alternative camera views and, if the analysis of those views shows that any is superior to the current view (based on various factors and criteria that can be established on a customizable basis and used to “score” each camera, as illustrated in the example of FIG. 4), the system selects that “better” camera view. Typically, the alternative camera views that get evaluated are generally spread around a circle which is centered on the player's location within the virtual environment. For applications other than action video games, the arrangement of potential cameras can be any suitable configuration.

In some applications, for example, each camera view can be scored based on the number of targets the camera would have on screen and multiplied by the “weights” that the programmer/designer has assigned to each of the targets. In passing, for many video games, it is useful to program the player's avatar as a POI and weight it very heavily, so that the system will be biased heavily toward including the avatar within the selected camera view.

As mentioned above, the evaluation or scoring of each camera's view also can take into account potentially “negative” factors. Such factors include if there is any piece of virtual geometry or a combat camera “blocking volume” blocking the player. The score is further reduced by the percentage of the distance the camera must push forward in order to be closer to the player than the collision it detected. In certain of the embodiments discussed above, each camera view is then further penalized based on its orientation to the current view. Camera views that are facing forward are worth their full score, views facing to either side are worth 50% of their total score, and the views facing backwards or opposite to the current camera view are worth 25%. The best camera view out of the set is stored via a vector from the target to the suggested camera location and is used when the camera updates its position in a later PostMod process.

In a preferred game application, the algorithm of FIG. 2 scores the current camera view, and if any enemies are within range it calls for the ring of camera views to be scored to find out if there is a better camera position. Otherwise, the system determines the camera position by evaluating the remainder of the PostMods in the modifier stack.

In certain embodiments of the invention, each character or avatar can have a number of dynamically-updated cameras whose position and rotation change depending on the location of the character in the world. This can provide to a programmer or designer a large numbers of potential cameras from which to choose at any given time, and the camera can be selected by the Best Point of View algorithm (discussed above). Such embodiments are analogous to a major sporting event where there are many cameras placed throughout the venue, all simultaneous providing a different view of the action, with a coordinator (here, the logic of the various algorithms and the modifier stack) making a decision about which shot best frames the current action.

The algorithm illustrated in FIG. 3 scores a single camera view by going through the list of targets, validating those targets, and adding their score to the camera's total. It also applies a penalty to the camera view's score when it detects a collision between the camera location and the target (which may be the player/avatar). After all of these calculations, it returns the score.

As discussed above, in certain embodiments the camera's movement is controlled by a dampening system such as a three-point interpolation system. The “movement dampening” can help provide smooth camera movement while track a moving target (the player/avatar) whose velocity is neither constant nor straight. As indicated above, the interpolation algorithm uses three points or values:
Current Point/Value/Location: Where the interpolated value actually is. This value is always used in calculations to achieve smooth motion.
Middle or “Desired” Value: This point moves a fixed distance at a fixed frequency. For example, it may step 10 world units ever 1/60th of a second. This point moves in a straight line towards the final (or ideal) value or point.
Final/Ideal Value: This is the final location to where the interpolator is trying to go. Preferably, this value can immediately snap to any location, because the system protects the user against experiencing anything other than a smooth motion.

In many applications, the designer can manually place “volumes” into the virtual environment using an offline editor. These volumes encompass a given area of the virtual world, and can provide a means for the designers to give information to the camera system.
Property Volumes: these can allow for basic properties of the camera to be modified when the target is within a volume. (such as target and camera offsets, FOV, Speeds, Sponge Factors, etc)
Trajectory Volumes: these can allow for the camera to be forced to face a given direction (but still aimed at the target).
Point of Influence Volumes: give the ability to specify an actor (the influence actor) to focus the camera on in addition to the target. Each Point Of Influence Volume has a Point Of Influence Circle. When the target enters this circle and nears the centre of the circle, the camera will progressively focus on the influence actor. An option also allows the camera to always keep the target in view.

As mentioned above, PostMod's preferably can be applied in a “stack” form, allowing a designer to push and pop various modifiers. In one embodiment, each PostMod stands alone as a single task to be accomplished. This allows combinations of various modifiers to influence the camera behavior, and also allows the camera to have a sense of “state” so that transitioning to these styles or modifications is transparent. Examples of “PostMod” or other Modifications that include the following, although the system is flexible enough to allow a wide variety of additional modifiers beyond and/or instead of those listed here:
Cornering: This post mod will physically rotate the camera around corners.
Basic Properties: This will apply some offsets which can be read in from configuration file
Styles Post Mod: The camera can have “styles” on it which are read in from a configuration file. Each style is a collection of properties which will be applied.
Point Of Influence: This will watch for volumes that the player stands in which have a point of interest attached to it. The camera will rotate towards this point to show it. (placed in editor in advance)
Properties Volumes: Allows the properties of the camera to be changed on the fly when inside of a particular volume (placed in editor)
Trajectory Volumes: Forces the camera to align to a certain direction along a combination of the x/y/z axis. (placed in editor)
Camera Aiming: This allows a button press to cause the camera to snap to be behind the target and allow a “free look” on the thumbstick to look around
In a preferred application, the camera's base motion uses two interpolators that track the current camera's position as well as the target's location. Typically, the target location tracks the root of the character, although as the character animates through the world, this motion can be erratic. To dampen the erratic aspects of this motion, designers and programmers can apply additional interpolators.

In certain video game or similar applications, when the camera is not constrained to a spline, plane or a point, the ideal position of the camera typically can be some distance away from the player with a target at the player's location. In addition, there is a target and camera offset which preferably are specified in the camera's local space. These are added on to the base locations to give the camera additional height and rotation.

When transitioning to and from placed cameras, the generic position logic (including any PostMod stack logic) preferably is applied. In some embodiments, the camera also can have the ability to cut immediately to the new location.

As mentioned above, the system preferably includes a means or method or dampening the “virtual movement” of the camera that is experienced by the human user. Although other dampening approaches can be employed, the example of the drawings uses a “3-Point Iterative Calculation Algorithm” (or “3PICA”). As illustrated in FIG. 2, such an approach can include accumulating the “unused” delta time for each update/rendering of the display/frame (block 200). As indicated in block 202, if that accumulated time is at least as great as the update frequency that has been programmed for the 3PICA itself (which commonly is set at or around 1/60th of a second), the system preferably returns to block 200 to accumulate further time as part of the next update/rendering of the display/frame.

Once sufficient time has accumulated for the logic to pass through block 202, block 204 illustrates that the system determine the number of camera position updates that can be achieved within that accumulated time. This can be conveniently done, for example, by taking the largest whole number y that results from dividing the frequency of the 3PICA into the accumulated frame time (or “delta time”). For y number of times, the 3PICA then iterates or cycles through the two calculations shown in Iteration Loop 214 (blocks 206 and 208). The logic illustrated in block 206 calculate a line from the desired/middle point or value towards the ideal/final point or value, and moves the desired/middle point or value “desired speed” units in that direction. It also ensures that the desired point does not “overshoot” the ideal/final point. The logic illustrated in block 208 calculate a line from the “current” point/value towards the “desired”/middle value, and moves the “current” value along this line, by a “sponge factor.” This sponge factor preferably is a value between 0 and 1, and is selected by the programmer to determine the percentage of the calculated distance that the current value/point (the camera's current position) should be moved. For example, a sponge factor value of 0.5 means the current point moves halfway along the line calculated in block 208.

The apparatus and methods of the present invention have been described with some particularity, but the specific designs, constructions, and steps disclosed are not to be taken as delimiting of the invention. Modifications and further alternatives will make themselves apparent to those of ordinary skill in the art, all of which will not depart from the essence of the invention and all such changes and modifications are intended to be encompassed within the appended claims.

What is claimed is:

1. A computer system for facilitating human interaction in a virtual environment, the system comprising:
an algorithm-driven camera system, programmed to operate in a fast paced dynamic environment without modifying the state of the objects in that environment, said system using the human's input of movements and actions within the virtual environment to determine and frame a camera view for display to the human, without any need for separate input from the human to operate the camera.

2. The system of claim 1, in which at least one algorithm takes into account cinematographic or other “rules” that can be created and/or selected by a programmer, and then automatically controls the camera view experienced by the human according to said rules.

3. The system of claim 1, in which at least one algorithm takes into account cinematographic or other “rules” that can be created and/or selected by the human, and then automatically controls the camera view experienced by the human according to said rules.

4. The system of claim 1 or claim 2 or claim 3, in which the system includes a human-controlled main character, and at least one algorithm takes into account and analyzes relevant information in the virtual scene such as the position of the human-controlled main character, the position of other characters in the scene, environmental features, various special effects, and the occurrence of special events during the human's use of the system.

5. Apparatus for providing interaction between one or more humans and a 3D virtual environment, including:
a 3D virtual environment, said environment including a plurality of points of interest that are preselected and weighted in importance by a programmer;
at least one main character within the environment;
a display device for displaying the environment to said one or more humans;
a control device by which said one or more humans can control said character, including moving said character within the environment;
a plurality of cameras that are programmed to travel with the main character as that character moves within the environment; and
a modifier stack module, said module including the ability to automatically select from among said cameras the one that will be displayed on said display device to said one or more humans.

6. The apparatus of claim 5, in which said modifier stack module uses said plurality of weighted points of interest in the automatic camera selection process.

7. The apparatus of claim 5, including a dampening module to smooth transitions in the virtual camera movement displayed to said one or more humans.

8. The apparatus of claim 5, including means for dampening the virtual camera movement displayed to said one or more humans.

9. The apparatus of claim 5 or claim 6, in which said dampening involves an iterative algorithm using at least three points within said virtual environment.

10. A method for selecting a camera view within a virtual 3D environment, including:
providing a virtual 3D environment having programmed therein points of interest (POIs) identified as having relative degrees of importance;
providing a plurality of camera views into that virtual world;
using said relative degrees of importance of said POIs to select from those camera views the camera view to be displayed to a human interacting with the virtual environment, without requiring human control of said camera view.

11. A computer-readable storage medium having stored therein instructions capable of causing a computer to perform the method of claim 10.

12. A method for controlling the simulated movement of a camera through a virtual 3D environment, including:
providing means for determining an ideal viewpoint to display from the virtual environment;
providing means for determining the camera viewpoint current being displayed;
providing means for smoothly transitioning the viewpoint being displayed from the current viewpoint toward the ideal viewpoint.

13. The method of claim 12, including using a dampening algorithm to help accomplish the step of smoothly transitioning the camera viewpoint.

14. A computer-readable storage medium having stored therein instructions capable of causing a computer to perform the method of claim 12.

15. A computer-readable storage medium having stored therein instructions capable of causing a computer to perform the method of claim 13.
